(19) United States
(12) Patent Application Publication
(10) Pub. No.: US 2026/0197855 A1
(43) Pub. Date: Jul. 9, 2026

(54) OPPORTUNISTIC TIME DOMAIN BEAM PREDICTION REPORTING

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US); Tao LUO, San Diego, CA (US)

(21) Appl. No.: 19/134,145

(22) PCT Filed: Jan. 20, 2023
(86) PCT No.: PCT/CN2023/073322

§ 371 Date: May 29, 2025

(51) Int. Cl. H04W 72/542; H04W 72/1268

(52) U.S. Cl. CPC H04W 72/542; H04W 72/1268

(57) ABSTRACT

Methods, systems, and devices for wireless communications are described. For example, the described techniques provide for opportunistic reporting of predicted channel characteristics. For example, predicted channel characteristic reports (e.g., for beam prediction) may be reported by a user equipment (UE) to a network entity opportunistically when a triggering condition is satisfied. Such opportunistic reporting of predicted channel characteristics may result in saving resource overhead and power at the UE compared to periodic reporting of predicted channel characteristics. A UE may report the predicted beam measurements based on the predicted values satisfying a triggering condition. Once the triggering condition is satisfied, the UE may either autonomously report the predicted beam measurements or may request from the network a resource to report the predicted beam measurements. The UE may report the predicted beam measurements in a separate transmission from the actual channel measurement report, such as a channel state information (CSI) report.

### CROSS REFERENCE

The present Application is a 371 national phase filing of International PCT Application No. PCT/CN2023/073322 by L1 et al., entitled “OPPORTUNISTIC TIME DOMAIN BEAM PREDICTION REPORTING,” filed Jan. 20, 2023, which is assigned to the assignee hereof, and which is expressly incorporated by reference in its entirety herein.

### FIELD OF TECHNOLOGY

The following relates to wireless communications, including opportunistic time domain beam prediction reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support opportunistic time domain beam prediction reporting. For example, the described techniques provide for opportunistic reporting of predicted channel characteristics. For example, predicted channel characteristic reports (e.g., for beam prediction) may be reported opportunistically by a user equipment (UE) to a network entity when a triggering condition is satisfied. Such opportunistic reporting of predicted channel characteristics may result in saving resource overhead and power at the UE compared to periodic reporting of predicted channel characteristics. A UE may report the predicted beam measurements based on the predicted values satisfying a triggering condition. Once the triggering condition is satisfied, the UE may either autonomously report the predicted beam measurements or may request from the network a resource to report the predicted beam measurements. The UE may report the predicted beam measurements in a separate transmission from the actual channel measurement report, such as a channel state information (CSI) report.

A method for wireless communications at a UE is described. The method may include receiving, from a network entity, a set of reference signals, transmitting, to the network entity, a first measurement report that indicates a set of actual channel measurements generated based on measurements of the set of reference signals on a corresponding set of receive beams at the UE, and transmitting, to the network entity, a second measurement report that indicates a set of predicted channel measurements, transmission of the second measurement report based on the set of predicted channel measurements satisfying a triggering condition, the set of predicted channel measurements associated with the set of receive beams at the UE.

An apparatus for wireless communications at a UE is described. The apparatus may include a processor, memory coupled with the processor, and instructions stored in the memory. The instructions may be executable by the processor to cause the apparatus to receive, from a network entity, a set of reference signals, transmit, to the network entity, a first measurement report that indicates a set of actual channel measurements generated based on measurements of the set of reference signals on a corresponding set of receive beams at the UE, and transmit, to the network entity, a second measurement report that indicates a set of predicted channel measurements, transmission of the second measurement report based on the set of predicted channel measurements satisfying a triggering condition, the set of predicted channel measurements associated with the set of receive beams at the UE.

Another apparatus for wireless communications at a UE is described. The apparatus may include means for receiving, from a network entity, a set of reference signals, means for transmitting, to the network entity, a first measurement report that indicates a set of actual channel measurements generated based on measurements of the set of reference signals on a corresponding set of receive beams at the UE, and means for transmitting, to the network entity, a second measurement report that indicates a set of predicted channel measurements, transmission of the second measurement report based on the set of predicted channel measurements satisfying a triggering condition, the set of predicted channel measurements associated with the set of receive beams at the UE.

A non-transitory computer-readable medium storing code for wireless communications at a UE is described. The code may include instructions executable by a processor to receive, from a network entity, a set of reference signals, transmit, to the network entity, a first measurement report that indicates a set of actual channel measurements generated based on measurements of the set of reference signals on a corresponding set of receive beams at the UE, and transmit, to the network entity, a second measurement report that indicates a set of predicted channel measurements, transmission of the second measurement report based on the set of predicted channel measurements satisfying a triggering condition, the set of predicted channel measurements associated with the set of receive beams at the UE.

Some examples of the method, apparatuses, and non-transitory computer-readable medium described herein may further include operations, features, means, or instructions for transmitting, to the network entity based on the set of predicted channel measurements satisfying the triggering condition, an indication that the UE will transmit the second measurement report and receiving, from the network entity and in response to the indication that the UE will transmit the second measurement report, a grant for an uplink resource for the second measurement report, where the second measurement report may be transmitted via the uplink resource.

In some examples of the method, apparatuses, and non-transitory computer-readable medium described herein, transmitting the indication that the UE will transmit the second measurement report may include operations, features, means, or instructions for transmitting the indication in the first measurement report.

Some examples of the method, apparatuses, and non-transitory computer-readable medium described herein may further include operations, features, means, or instructions for receiving, from the network entity, control signaling indicating the triggering condition in association with a CSI reporting configuration, where the first measurement report may be a CSI report.

In some examples of the method, apparatuses, and non-transitory computer-readable medium described herein, transmitting the indication in the first measurement report may include operations, features, means, or instructions for transmitting the indication in a first CSI report, where the grant for the uplink resource schedules transmission of a second CSI report, where the first measurement report may be the first CSI report and the second measurement report may be the second CSI report.

In some examples of the method, apparatuses, and non-transitory computer-readable medium described herein, a first CSI report setting of the first CSI report includes a second identifier for a second CSI report setting of the second CSI report, or the second CSI report setting of the second CSI report includes a first identifier for the first CSI report setting of the first CSI report.

In some examples of the method, apparatuses, and non-transitory computer-readable medium described herein, a medium access control (MAC) control element (CE) that activates the grant for the uplink resource includes an indication of a first identifier for a first CSI report setting of the first CSI report.

In some examples of the method, apparatuses, and non-transitory computer-readable medium described herein, the set of predicted channel measurements satisfying the triggering condition may include operations, features, means, or instructions for a first predicted measurement for a first receive beam exceeding a second predicted measurement for a second receive beam by a first threshold amount, both the first receive beam and the second receive beam being of the set of receive beams, the second receive beam corresponding to a strongest measurement included in the first measurement report, or the second receive beam being associated with a transmission configuration indicator state associated with a most recently scheduled downlink transmission.

In some examples of the method, apparatuses, and non-transitory computer-readable medium described herein, the set of predicted channel measurements satisfying the triggering condition may include operations, features, means, or instructions for determining that the first predicted measurement for the first receive beam exceeds the second predicted measurement for the second receive beam by the first threshold amount with a confidence level exceeding a second threshold amount.

In some examples of the method, apparatuses, and non-transitory computer-readable medium described herein, the set of predicted channel measurements satisfying the triggering condition may include operations, features, means, or instructions for a predicted measurement for a first receive beam of the set of receive beams exceeding, by a threshold, each of one or more second predicted measurements for corresponding one or more second receive beams of the set of receive beams, where the one or more second receive beams may have corresponding actual measurements in the first measurement report, and where the first receive beam may be different from any of the one or more second receive beams.

Some examples of the method, apparatuses, and non-transitory computer-readable medium described herein may further include operations, features, means, or instructions for receiving, from the network entity, control signaling indicating the triggering condition in association with a serving cell or an active bandwidth part for the UE.

In some examples of the method, apparatuses, and non-transitory computer-readable medium described herein, transmitting the second measurement report may include operations, features, means, or instructions for multiplexing an aperiodic CSI report on an uplink shared channel transmission, the aperiodic CSI report including the second measurement report, where a medium access control header of the uplink shared channel transmission indicates that the aperiodic CSI report may be multiplexed on the uplink shared channel transmission.

Some examples of the method, apparatuses, and non-transitory computer-readable medium described herein may further include operations, features, means, or instructions for transmitting, to the network entity during an initial access procedure with the network entity, an indication of the triggering condition.

In some examples of the method, apparatuses, and non-transitory computer-readable medium described herein, communicating, with the network entity, control signaling updating the triggering condition.

A method for wireless communications at a network entity is described. The method may include transmitting, to a UE, a set of reference signals, receiving, from the UE, a first measurement report that indicates a set of actual channel measurements generated based on measurements of the set of reference signals on a corresponding set of receive beams at the UE, and receiving, from the UE, a second measurement report that indicates a set of predicted channel measurements, transmission of the second measurement report based on the set of predicted channel measurements satisfying a triggering condition, the set of predicted channel measurements associated with the set of receive beams at the UE.

An apparatus for wireless communications at a network entity is described. The apparatus may include a processor, memory coupled with the processor, and instructions stored in the memory. The instructions may be executable by the processor to cause the apparatus to transmit, to a UE, a set of reference signals, receive, from the UE, a first measurement report that indicates a set of actual channel measurements generated based on measurements of the set of reference signals on a corresponding set of receive beams at the UE, and receive, from the UE, a second measurement report that indicates a set of predicted channel measurements, transmission of the second measurement report based on the set of predicted channel measurements satisfying a triggering condition, the set of predicted channel measurements associated with the set of receive beams at the UE.

Another apparatus for wireless communications at a network entity is described. The apparatus may include means for transmitting, to a UE, a set of reference signals, means for receiving, from the UE, a first measurement report that indicates a set of actual channel measurements generated based on measurements of the set of reference signals on a corresponding set of receive beams at the UE, and means for receiving, from the UE, a second measurement report that indicates a set of predicted channel measurements, transmission of the second measurement report based on the set of predicted channel measurements satisfying a triggering condition, the set of predicted channel measurements associated with the set of receive beams at the UE.

A non-transitory computer-readable medium storing code for wireless communications at a network entity is described. The code may include instructions executable by a processor to transmit, to a UE, a set of reference signals, receive, from the UE, a first measurement report that indicates a set of actual channel measurements generated based on measurements of the set of reference signals on a corresponding set of receive beams at the UE, and receive, from the UE, a second measurement report that indicates a set of predicted channel measurements, transmission of the second measurement report based on the set of predicted channel measurements satisfying a triggering condition, the set of predicted channel measurements associated with the set of receive beams at the UE.

Some examples of the method, apparatuses, and non-transitory computer-readable medium described herein may further include operations, features, means, or instructions for receiving, from the UE based on the set of predicted channel measurements satisfying the triggering condition, an indication that the UE will transmit the second measurement report and transmitting, to the UE and in response to the indication that the UE will transmit the second measurement report, a grant for an uplink resource for the second measurement report, where the second measurement report may be transmitted via the uplink resource.

In some examples of the method, apparatuses, and non-transitory computer-readable medium described herein, receiving the indication that the UE will transmit the second measurement report may include operations, features, means, or instructions for receiving the indication in the first measurement report.

Some examples of the method, apparatuses, and non-transitory computer-readable medium described herein may further include operations, features, means, or instructions for transmitting, to the UE, control signaling indicating the triggering condition in association with a CSI reporting configuration, where the first measurement report may be a CSI report.

In some examples of the method, apparatuses, and non-transitory computer-readable medium described herein, receiving the indication in the first measurement report may include operations, features, means, or instructions for receiving the indication in a first CSI report, where the grant for the uplink resource schedules transmission of a second CSI report, where the first measurement report may be the first CSI report and the second measurement report may be the second CSI report.

In some examples of the method, apparatuses, and non-transitory computer-readable medium described herein, a first CSI report setting of the first CSI report includes a second identifier for a second CSI report setting of the second CSI report, or the second CSI report setting of the second CSI report includes a first identifier for the first CSI report setting of the first CSI report.

In some examples of the method, apparatuses, and non-transitory computer-readable medium described herein, a MAC-CE that activates the grant for the uplink resource includes an indication of a first identifier for a first CSI report setting of the first CSI report.

In some examples of the method, apparatuses, and non-transitory computer-readable medium described herein, the set of predicted channel measurements satisfying the triggering condition may include operations, features, means, or instructions for a first predicted measurement for a first receive beam exceeding a second predicted measurement for a second receive beam by a first threshold amount, both the first receive beam and the second receive beam being of the set of receive beams, the second receive beam corresponding to a strongest measurement included in the first measurement report, or the second receive beam being associated with a transmission configuration indicator state associated with a most recently scheduled downlink transmission.

In some examples of the method, apparatuses, and non-transitory computer-readable medium described herein, the set of predicted channel measurements satisfying the triggering condition may include operations, features, means, or instructions for a predicted measurement for a first receive beam of the set of receive beams exceeding, by a threshold, each of one or more second predicted measurements for corresponding one or more second receive beams of the set of receive beams, where the one or more second receive beams may have corresponding actual measurements in the first measurement report, and where the first receive beam may be different from any of the one or more second receive beams.

Some examples of the method, apparatuses, and non-transitory computer-readable medium described herein may further include operations, features, means, or instructions for transmitting, to the UE, control signaling indicating the triggering condition in association with a serving cell or an active bandwidth part for the UE.

In some examples of the method, apparatuses, and non-transitory computer-readable medium described herein, receiving the second measurement report may include operations, features, means, or instructions for receiving an aperiodic CSI report multiplexed on an uplink shared channel transmission, the aperiodic CSI report including the second measurement report, where a medium access control header of the uplink shared channel transmission indicates that the aperiodic CSI report may be multiplexed on the uplink shared channel transmission.

Some examples of the method, apparatuses, and non-transitory computer-readable medium described herein may further include operations, features, means, or instructions for receiving, from the UE, during an initial access procedure with the UE, an indication of the triggering condition.

In some examples of the method, apparatuses, and non-transitory computer-readable medium described herein, communicating, with the UE, control signaling updating the triggering condition.

### BRIEF DESCRIPTION OF THE DRAWINGS

FIG. 1 illustrates an example of a wireless communications system that supports opportunistic time domain beam prediction reporting in accordance with one or more aspects of the present disclosure.

FIG. 2 illustrates an example of a machine learning model that supports opportunistic time domain beam prediction reporting in accordance with one or more aspects of the present disclosure.

FIG. 3 illustrates an example of a wireless communications system that supports opportunistic time domain beam prediction reporting in accordance with one or more aspects of the present disclosure.

FIG. 4 illustrates an example of a wireless communications system that supports opportunistic time domain beam prediction reporting in accordance with one or more aspects of the present disclosure.

FIG. 5 illustrates an example of a process flow that supports opportunistic time domain beam prediction reporting in accordance with one or more aspects of the present disclosure.

FIGS. 6 and 7 illustrate block diagrams of devices that support opportunistic time domain beam prediction reporting in accordance with one or more aspects of the present disclosure.

FIG. 8 illustrates a block diagram of a communications manager that supports opportunistic time domain beam prediction reporting in accordance with one or more aspects of the present disclosure.

FIG. 9 illustrates a diagram of a system including a device that supports opportunistic time domain beam prediction reporting in accordance with one or more aspects of the present disclosure.

FIGS. 10 and 11 illustrate block diagrams of devices that support opportunistic time domain beam prediction reporting in accordance with one or more aspects of the present disclosure.

FIG. 12 illustrates a block diagram of a communications manager that supports opportunistic time domain beam prediction reporting in accordance with one or more aspects of the present disclosure.

FIG. 13 illustrates a diagram of a system including a device that supports opportunistic time domain beam prediction reporting in accordance with one or more aspects of the present disclosure.

FIGS. 14 through 17 illustrate flowcharts showing methods that support opportunistic time domain beam prediction reporting in accordance with one or more aspects of the present disclosure.

### DETAILED DESCRIPTION

In some wireless communications systems, a user equipment (UE) may report various parameters associated with one or more beams for communications between the UE and a network entity in a channel state report. The parameters reported may be configured by the network. The parameters may include a reference signal received power (RSRP) or a signal to interference and noise ratio (SINR) of the one or more beams. A UE may also be configured to predict and periodically report future predicted RSRP or SINR measurements, and/or a time when the predicted measurements are valid. Currently, the actual measurements and the predicted measurements are reported together—as part of a same report. However, if a UE is stationary or moving at a low rate, the strongest beams (determined based on the RSRP and/or SINR reporting) may not change often (e.g., may not change over hundreds of ms). Frequent reporting of the predicted measurement results (e.g., every 20 or 40 ms) may consume UE-specific overhead and power. Accordingly, static predicted beam reporting configurations may expend excessive overhead and power on predicted beam reporting in conditions where the strongest beam is not likely to change.

Aspects of the present disclosure relate to opportunistic reporting of predicted channel characteristics. For example, predicted channel characteristics (e.g., for beam prediction) may be reported opportunistically when a triggering condition is satisfied instead of periodically. Such opportunistic reporting of predicted channel characteristics may result in saving resource overhead and power at the UE. A UE may still predict various future beam measurements, however, instead of reporting the predicted beam measurements without regard to the predicted values, the UE may report the predicted beam measurements based on the predicted values satisfying a triggering condition. Once the triggering condition is satisfied, the UE may either autonomously report the predicted beam measurements or may request from the network a resource to report the predicted beam measurements. The UE may report the predicted beam measurements in a separate transmission from the actual channel measurement report, such as a channel state information (CSI) report. For example, the UE may identify that the predicted beam measurements satisfy the triggering condition, and in response may include an indication in the CSI report that the UE will separately transmit the predicted beam measurements. In response to receiving the CSI report, the network may grant a resource to the UE to transmit the predicted beam measurements, for example in a second CSI report. An example triggering condition may be when a predicted RSRP/SINR for a first beam is stronger than a predicted RSRP/SINR for a second beam by a threshold amount, where the second beam may be one of the strongest beam in the most recent CSI report or the beam associated with the transmission configuration indicator (TCI) state for a recently scheduled downlink transmission.

Aspects of the disclosure are initially described in the context of wireless communications systems. Aspects of the disclosure are further illustrated by and described with reference to machine learning models, process flows, apparatus diagrams, system diagrams, and flowcharts that relate to opportunistic time domain beam prediction reporting.

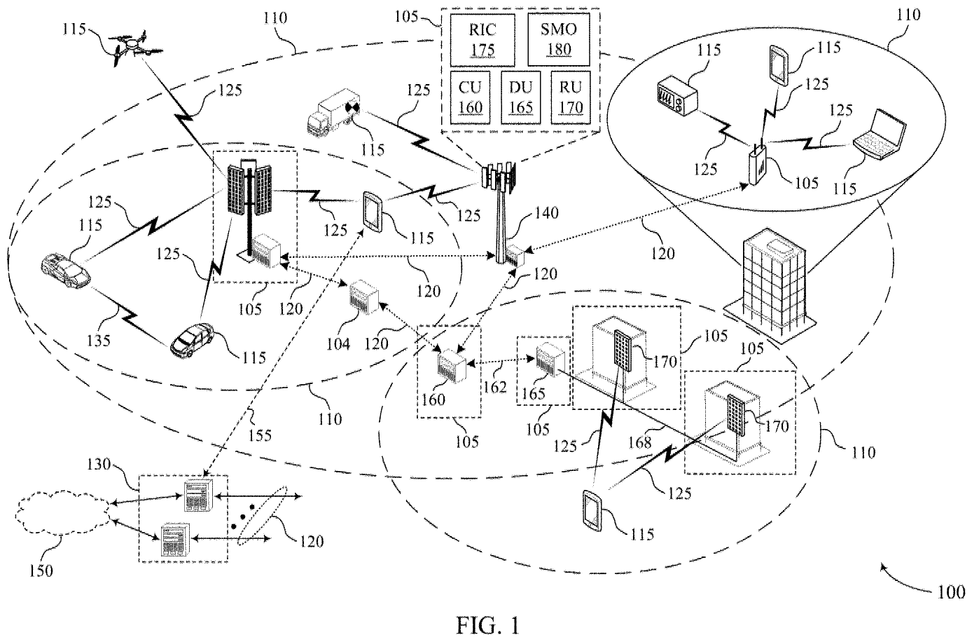

FIG. 1 illustrates an example of a wireless communications system 100 that supports opportunistic time domain beam prediction reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support opportunistic time domain beam prediction reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, wireless devices (e.g., UEs 115, network entities 105,) may support opportunistic reporting by the UE 115 of predicted channel characteristics. For example, predicted channel characteristics (e.g., for beam prediction) may be reported opportunistically by the UE 115 when a triggering condition is satisfied. Such opportunistic reporting of predicted channel characteristics may result in saving resource overhead and power at the UE 115 as compared to periodic reporting of predicted channel characteristics. A UE 115 may still predict various future beam measurements, however, instead of reporting the predicted beam measurements without regard to the predicted values, the UE 115 may report the predicted beam measurements based on the predicted values satisfying a triggering condition. Once the triggering condition is satisfied, the UE 115 may either autonomously report the predicted beam measurements or may request from the network a resource to report the predicted beam measurements. The UE 115 may report the predicted beam measurements in a separate transmission from the actual channel measurement report, such as a CSI report. For example, the UE 115 may identify that the predicted beam measurements satisfy the triggering condition, and in response may include an indication in the CSI report that the UE 115 will separately transmit the predicted beam measurements. In response to receiving the CSI report, the network may grant a resource to the UE 115 to transmit the predicted beam measurements, for example in a second CSI report. An example triggering condition may be when a predicted RSRP/SINR for a first beam is stronger than a predicted RSRP/SINR for a second beam by a threshold amount, where the second beam may be one of the strongest beam in the most recent CSI report or the beam associated with the TCI state for a recently scheduled downlink transmission.

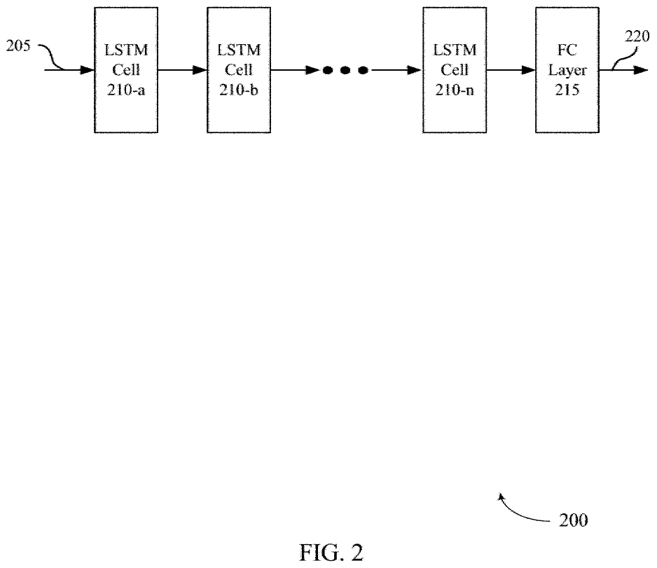

FIG. 2 illustrates an example of a machine learning model 200 that supports opportunistic time domain beam prediction reporting in accordance with one or more aspects of the present disclosure. In some examples, aspects of the machine learning model 200 may implement, or be implemented by, aspects of the wireless communications system 100.

As described herein, some wireless devices (e.g., UEs 115) may be configured to receive reference signals from the network using different receive beams, and perform measurements on the received reference signals in order to identify relative qualities of the respective receive beams. In such cases, the UEs 115 may transmit measurement reports (e.g., CSI reports) to the network indicating the measurements so that the network can schedule communications at the UE 115 using receive beams that are best for the UE 115 (e.g., receive beams that exhibit a threshold quality).

In some cases, UEs 115 may utilize past measurements to predict beam measurements (e.g., future receive beam qualities) at some point in the future, and may report the predicted/extrapolated beam measurements to the network. In some cases, machine learning techniques (e.g., long short-term memory (LSTM) based deep learning techniques) may be used to perform beam measurement prediction/extrapolation. For example, measurements (e.g., RSRP measurements) performed by a UE 115 and/or a network entity 105 may be passed as an input 205 into the machine learning model 200 (e.g., RSRP predictor) including one or more LSTM layers or cells (e.g., a first LSTM cell 210-a, a second LSTM cell 210-b, . . . , through an nth LSTM cell 210-n). In this example, the cell and hidden states of each LSTM cell layer may be recursively used by subsequent LSTM layers, where the machine learning model is configured to output predicted beam measurements 220 for the UE 115 (e.g., UE-based RSRP predictions) and/or the network entity 105 (e.g., network-based RSRP predictions). In some examples, the output of a last LSTM cell 210-n may be passed through a fully connected layer 215, which may output the predicted beam measurements 220 for the UE 115 (e.g., UE-based RSRP predictions) and/or the network entity 105 (e.g., network-based RSRP predictions). In some cases, predicted beam measurements 220 output by the machine learning model may be re-input into the machine learning model 200 in order to further train the machine learning model 200 and improve the ability of the model to perform future predictions.

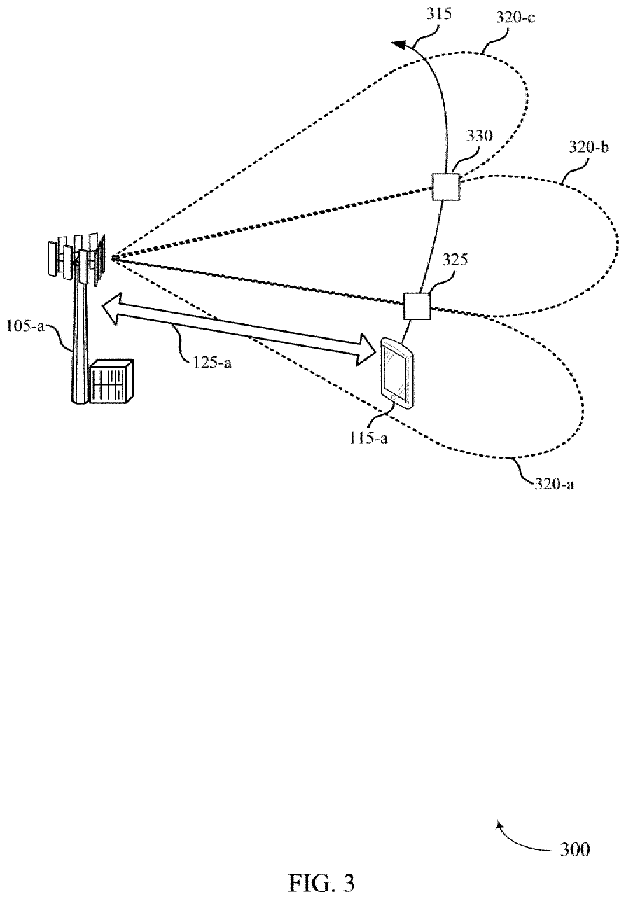

FIG. 3 illustrates an example of a wireless communications system 300 that supports opportunistic time domain beam prediction reporting in accordance with one or more aspects of the present disclosure. In some examples, the wireless communications system 300 may be implemented by or may implement aspects of the wireless communications system 100.

The network entity 105-a may communicate with the UE 115-a using directional communications techniques. For example, the network entity 105-a may communicate with the UE 115-a via one or more beams 320. The network entity 105-a may communicate with the UE 115-a via a communication link 125-a, which may be an example of an NR or LTE link between the UE 115-a and the network entity 105-a. In some cases, the communication link 125-a may include an example of an access link (e.g., Uu link). The communication link 125-a may include a bi-directional link that enables both uplink and downlink communication.

As the UE 115-a moves along a path 315, the strongest beam 320 may change. For example, at point 325, the strongest beam may change from beam 320-a to beam 320-b, and at point 330, the strongest beam may change from beam 320-b to beam 320-c. When the UE 115-a moves along the path 315 at a slow speed (e.g., if an operator is walking), the beams may largely be stationary (e.g., at a 20 ms beam management cycle, the strongest beam may be unchanged in 90% of the beam management reports, and accordingly there may be no benefit to reporting the time domain beam prediction results).

For example, if the predicted layer 1 (L1) RSRPs of the beams imply no top-N beam changes (and/or the L1-RSRPs of the top-N beams do not vary significantly), beam prediction results may be less meaningful for beam management purposes. Accordingly, transmission of predicted beam measurements may lead to excessive power consumption and/or resource overhead at the UE 115-a in cases where the UE 115-a is stationary or moving at a low speed. Accordingly, described techniques support opportunistic time domain beam prediction reporting. For example, the UE 115-a may report predicted channel characteristics/beam measurements when a triggering condition is satisfied.

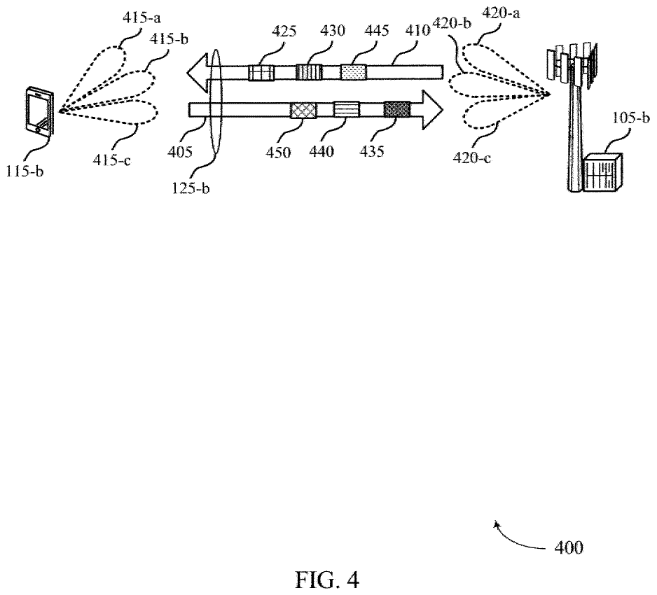

FIG. 4 illustrates an example of a wireless communications system 400 that supports opportunistic time domain beam prediction reporting in accordance with one or more aspects of the present disclosure. In some examples, the wireless communications system 400 may be implemented by or may implement aspects of the wireless communications system 100.

The network entity 105-b may communicate with the UE 115-b via a communication link 125-b, which may be an example of an NR or LTE link between the UE 115-b and the network entity 105-b. In some cases, the communication link 125-b may include an example of an access link (e.g., Uu link). The communication link 125-b may include a bi-directional link that enables both uplink and downlink communication. For example, the UE 115-b may transmit uplink signals 405, such as uplink control signals or uplink data signals, to the network entity 105-b using the communication link 125-b, and the network entity 105-b may transmit downlink signals 410, such as downlink control signals or downlink data signals, to the UE 115-b using the communication link 125-b. The network entity 105-b may communicate with the UE 115-b using directional communications techniques. For example, the network entity 105-b may transmit downlink signals 410 to the UE 115-b via one or more beams 420 (e.g., transmit beam 420-a, transmit beam 420-b, transmit beam 420-c), and the UE 115-b may receive downlink signals 410 using one or more receive beams 415 (e.g., receive beam 415-a, receive beam 415-b, receive beam 415-c). Similarly, the UE 115-b may transmit uplink signals 405 to the network entity 105-b using one or more transmit beams at the UE 115-b that correspond to the receive beams 415.

The UE 115-b may receive reference signals 425 (e.g., CSI-RSs) from the network entity 105-b. In some cases, the reference signals 425 may be received within channel measurement resources (CMRs) which may be preconfigured and/or signaled to the UE 115-b (e.g., via control signaling 430). The UE 115-b may perform beam measurements on the CMRs based on a beam management periodicity, which may be indicated in control signaling 430. For example, the beam measurements may correspond to the receive beams 415 the UE 115-b uses to receive the reference signals 425 and that are configured for the CMRs. For example, the UE 115-b may carry out actual beam measurements at beam measurement occasions associated with an anchor periodicity, and may report the measurement back to the network entity 105-b, for example in a CSI report 435. At some anchor beam management occasions, the UE 115-b may predict L1-RSRPs of the CMRs for a number of time domain prediction occasions between two anchor beam management occasions. In some examples, the UE 115-b may indicate via the CSI report 435 whether the UE 115-b will transmit additional information related to the predicted results. In some examples, predicted measurement report 440 may be transmitted in uplink control information, a MAC control element (MAC-CE), or a configured grant (CG) physical uplink shared channel (PUSCH). A triggering condition for transmission of the predicted measurement report 440 may be negotiated between the UE 115-b and the network entity 105-b or may be predefined (e.g., standardized).

For example, based on a triggering condition, the UE 115-b may indicate to the network entity 105-b that the UE 115-b will feed back predicted future channel characteristics (e.g., including L1-RSRP, L1-SINR, rank indicator (RI), precoding matrix indicator (PMI), channel quality index (CQI), or top-N resources in terms of L1-RSRP or L1-SINR strengths). The network entity 105-b may schedule an uplink resource (e.g., via an uplink grant 445) for the UE 115-b to transmit the predicted measurement report 440. In some examples, the UE 115-b may autonomously transmit the predicted measurement report 440 (e.g., without receiving an uplink grant for an uplink resource for the predicted measurement report 440).

In some examples, the triggering condition may be that a predicted L1-RSRP/L1-SINR for a first CMR for a future time domain occasion is stronger than the predicted L1-RSRP/LISINR for a second CMR for the same future time domain occasion by a threshold amount (e.g., by a threshold dB). The value of the threshold amount (e.g., in dBs) may be predefined (e.g., standardized), configured by the network entity 105-b (e.g., in control signaling 430), or reported by the UE 115-b (e.g., in uplink control signaling 450). The time domain offset between the future time domain occasion and the slot carrying the CSI reference resource associated with the most recent L1 report may be predefined (e.g., standardized), configured by the network entity 105-b (e.g., in control signaling 430), or reported by the UE 115-b (e.g., in uplink control signaling 450 such as RRC together with capability reporting during initial access). In some examples, the UE 115-b may dynamically update the triggering condition via a MAC-CE.

For example, the second CMR may be the CMR that had the strongest L1-RSRP/L1-SINR in the most recent L1 beam report (e.g., in the most recent CSI report 435), and the first CMR may be different that any CMR addressed in the most recent L1 beam report. For example, in a most recent L1 beam report, CMR #3 has a value (e.g., L1-RSRP/L1-SINR) of −75 dBm, CMR #4 has a value of −81 dBm, MR #5 has a value of −87 dBm, and CMR #2 has a value of −89 dBm. The UE 115-b may predict for a future time domain occasion that CMR #2 has a value of −75 dBm, CMR #7 has a value of −79 dBm, CMR #3 has a value of −83 dBm, and CMR #4 has a value of −89 dBM. CMR #3, which had the highest value in the recent L1 beam report, has a predicted value (−83 dBm) that is less than the new predicted best CMR (CMR #7 at −79 dBM) by 4 dBM. Accordingly, if the triggering condition is less than 4 dBM, the triggering condition would be satisfied.

As another example, the second CMR may be the source reference signal of the TCI state for the most recently scheduled physical downlink control channel (PDCCH) or physical downlink shared channel (PDSCH) transmission. For example, in a most recent L1 beam report, CMR #3 has a value (e.g., L1-RSRP/L1-SINR) of −75 dBm, CMR #4 has a value of −81 dBm, MR #5 has a value of −87 dBm, and CMR #2 has a value of −89 dBm, and CMR #3 may be the source RS of the TCI state for the most recently scheduled PDCCH or PDSCH transmission. The UE 115-b may predict for a future time domain occasion that CMR #2 has a value of −75 dBm, CMR #7 has a value of −79 dBm, CMR #3 has a value of −83 dBm, and CMR #4 has a value of −89 dBM. CMR #3, which was the source RS of the TCI state for the most recently scheduled PDCCH or PDSCH transmission, has a predicted value (−83 dBm) that is less than the new predicted best CMR (CMR #7 at −79 dBM) by 4 dBM. Accordingly, if the triggering condition is less than 4 dBM, the triggering condition would be satisfied.

As another example, there may be multiple second CMRs, which are the CMRs addressed in the most recent L1 beam report (e.g., in the most recent CSI report 435, such that the predicted L1-RSRP/L1-SINR of the first CMR is stronger by a threshold amount (e.g., by a threshold dB) than any of the predicted L1-RSRP/L1-SINR of the second CMRs. For example, in a most recent L1 beam report, CMR #3 has a value (e.g., L1-RSRP/L1-SINR) of −75 dBm, CMR #4 has a value of −81 dBm, MR #5 has a value of −87 dBm, and CMR #2 has a value of −89 dBm. The UE 115-b may predict for a future time domain occasion that CMR #7 has a predicted value of −75 dBm, CMR #5 has a value of −79 dBm, CMR #2 has a value of −87 dBm, and CMR #3 has a value of −87 dBM. In the predicted measurements, CMR #7 has the highest predicted value at −75 dBm, which is more than the next closest predicted value (−79 dBm for CMR #5) by 4 dBM, and CMR #7 was not included in the most recent L1 beam report. Accordingly, if the triggering condition is less than 4 dBM, the triggering condition would be satisfied.

In some examples, the triggering condition may include a confidence level associated with such predicted values (e.g., the triggering condition may include a confidence level above a threshold). For example, the threshold confidence level may be defined as standard deviations associated with the predicted L1-RSRPs. As another example, the threshold confidence level may be defined as a normalized metric represented in percentages. The value of the threshold confidence level may be predefined (e.g., standardized), configured by the network entity 105-b (e.g., in control signaling 430), or reported by the UE 115-b (e.g., in uplink control signaling 450).

As described herein, the triggering condition may be configured by the network entity 105-b. For example, the triggering condition may be configured via RRC signaling per serving cell or per BWP. As another example, the triggering condition may be configured via RRC signaling in the CSI report setting with respect to the CSI report carrying the actual measurements (e.g., the RRC configuration for the CSI report 435). As another example, the triggering condition may be configured via a MAC-CE activating the semi-periodic CSI report carrying the actual measurements (e.g., the CSI report 435 is a semi-periodic CSI report activated by MAC-CE). As another example, the triggering condition may be configured via RRC signaling in the parameter CSI-AssociatedReportConfigInfo associated with the aperiodic CSI report 435 carrying actual channel measurements.

In some examples, where the UE 115-b may autonomously report the predicted channel characteristics in a predicted measurement report 440, the triggering condition may be RRC configured per serving cell or per BWP. In some examples, where the UE 115-b may autonomously report the predicted channel characteristics in a predicted measurement report 440, the triggering condition may be predefined (e.g., standardized).

In some examples, the UE 115-b may feed back, through the first CSI report 435, actual channel measurements (e.g., L1-RSRPs/L1-SINRs associated with the CMRs) and whether the UE 115-b will feed back predicted future channel characteristics to the network entity 105-b (based on the triggering condition). For example, a new bit may be introduced to the CSI report 435 as an addition reportQuantity to indicate whether the UE 115-b will feed back predicted future channel characteristics to the network entity 105-b. If the UE 115-b indicates the UE 115-b will feed back predicted future channel characteristics to the network entity 105-b, the UE 115-b may expect to be triggered with a second aperiodic CSI report or activated with a second semi-periodic CSI report to feed back such future channel characteristics in a predicted measurement report 440 (e.g., the UE 115-b expects an uplink grant 445 scheduling an aperiodic CSI report or a MAC-CE activating a semi-periodic CSI report that the UE 115-b may use to transmit the predicted measurement report 440).

In some examples, the predicted measurement report 440 (e.g., the second CSI report) may be linked to the first CSI report 435. For example, the CSI report setting identifier (ID) of the first CSI report 435 may be included in the CSI report setting of the second aperiodic/semi-periodic CSI report, or the CSI report setting ID of the first CSI report 435 may be included in the CSI-AssociatedReportConfigInfo for the second aperiodic CSI report. As another example, the CSI report setting ID of the second aperiodic/semi-periodic CSI report may be included in the CSI report setting of the first CSI report 435, or the CSI-AssociatedReportConfigInfo ID or CSI-AperiodicTriggerState ID of the second aperiodic CSI report may be included in the CSI report setting of the first CSI report 435. As another example, the CSI report setting ID of the first CSI report 435 may be indicated by the MAC-CE activating the second semi-periodic CSI report. In some examples, consecutive numbers of semi-periodic CSI reports may be associated with multiple prediction cycles, such that the network entity 105-b may track the prediction more closely.

In some examples, if the UE 115-b has a CG-PUSCH configuration, the second aperiodic/semi-periodic CSI report may be multiplexed on the most recently available CG-PUSCH occasion. In such examples, the CSI report setting ID of the first and/or second CSI report may be included in the CG-PUSCH configuration. In such examples, the CG-PUSCH configuration ID may be included in the CSI report setting of the first and/or second CSI report, or the CG-PUSCH configuration ID may be included in the CSI-AssociatedReportConfigInfo of the second aperiodic CSI report.

In some examples, the UE 115-b may autonomously transmit a predicted measurement report 440 (e.g., without receiving a grant for an uplink resource to transmit the predicted measurement report 440). For example, the UE 115-b may autonomously transmit a predicted measurement report 440 via a MAC-CE. As another example, the UE 115-b may autonomously transmit a predicted measurement report 440 via an aperiodic CSI report multiplexed on a PUSCH (e.g., a CG or non-CG PUSCH) without the network entity 105-b triggering a command for the aperiodic CSI report. In such examples, the MAC header of the PUSCH may indicate that the PUSCH includes the predicted measurement report 440. If the MAC header of the PUSCH indicates that the PUSCH includes the predicted measurement report 440, the PUSCH may indicate the CSI report setting, the CSI-AssociatedReportConfigInfo ID, or the CSI-AperiodicTriggerState ID associated with the aperiodic CSI report used for the predicted measurement report 440.

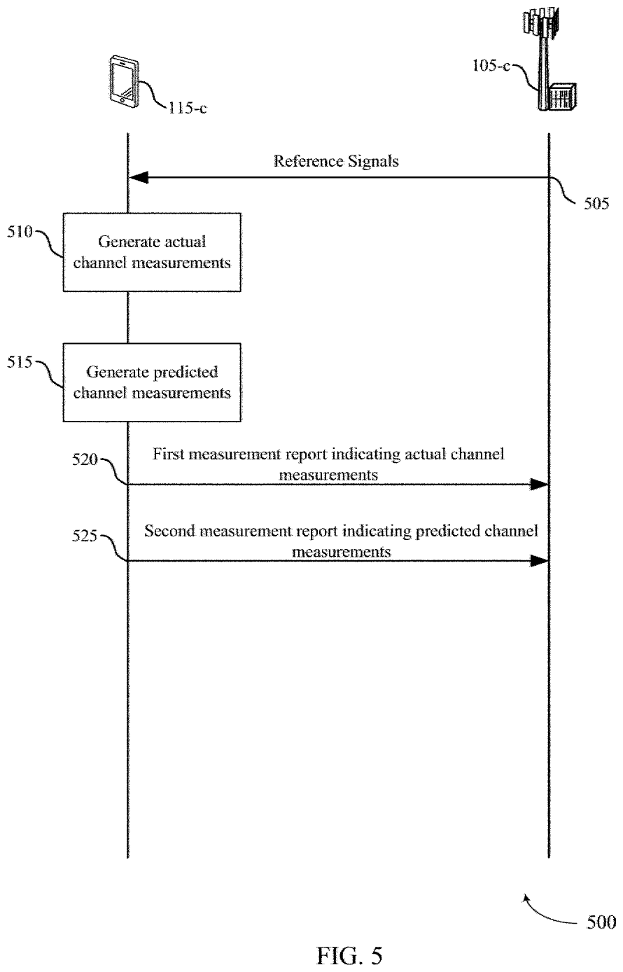

FIG. 5 illustrates an example of a process flow 500 that supports opportunistic time domain beam prediction reporting in accordance with one or more aspects of the present disclosure. In some examples, aspects of the process flow 500 may implement, or be implemented by, aspects of wireless communications systems 100, the machine learning model 200, the wireless communications system 300, the wireless communications system 400, or any combination thereof.

The process flow 500 includes a UE 115-c and a network entity 105-c, which may be examples of a UE 115 and a network entity 105 as described herein. In some examples, the operations illustrated in process flow 500 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 505, the UE 115-c may receive, from the network entity 105-c, a set of reference signals.

At 510, the UE 115-c may generate a set of actual channel measurements generated based on measurements of the set of reference signals on a corresponding set of receive beams at the UE 115-c.

At 515, the UE 115-c may generate a set of predicted channel measurements associated with the set of receive beams at the UE. For example, the UE 115-c may generate a set of predicted channel measurements using a machine learning model based on past channel measurement results, including the actual channel measurements generated at 510.

At 520, the UE 115-c may transmit, to the network entity 105-c, a first measurement report that indicates the set of actual channel measurements generated at 510.

At 525, the UE 115-c may transmit, to the network entity 105-c, a second measurement report that indicates the predicted channel measurements based on the predicted channel measurements satisfying a triggering condition.

In some examples, the UE 115-c may transmit, to the network entity 105-c based on the predicted channel measurements satisfying the triggering condition, an indication that the UE will transmit the second measurement report. The UE 115-c may receive, from the network entity 105-c and in response to the indication that the UE 115-c will transmit the second measurement report, a grant for an uplink resource for the second measurement report, and the UE 115-c may transmit the second measurement report at 525 via the uplink resource. In some examples, the UE 115-c may transmit the indication that the UE will transmit the second measurement report in the first measurement report. In some examples, the UE 115-c may receive, from the network entity 105-c, control signaling indicating the triggering condition in association with a CSI reporting configuration, and the first measurement report is a CSI report. In some examples, the UE 115-c may transmit the indication that the UE will transmit the second measurement report in a first CSI report, the grant for the uplink resource schedules transmission of a second CSI report, and the first measurement report is the first CSI report and the second measurement report is the second CSI report. In some examples, a first CSI report setting of the first CSI report includes a second identifier for a second CSI report setting of the second CSI report, or the second CSI report setting of the second CSI report includes a first identifier for the first CSI report setting of the first CSI report. In some examples, a MAC-CE that activates the grant for the uplink resource may include an indication of a first identifier for a first CSI report setting of the first CSI report.

In some examples, the triggering condition is satisfied when a first predicted measurement for a first receive beam exceeds a second predicted measurement for a second receive beam by a first threshold amount, both the first receive beam and the second receive beam being of the set of receive beams, the second receive beam corresponding to a strongest measurement included in the first measurement report, or the second receive beam being associated with a TCI state associated with a most recently scheduled downlink transmission (e.g., PDSCH or PDCCH transmission). In some examples, the triggering condition is satisfied when the UE 115-c determines that the first predicted measurement for the first receive beam exceeds the second predicted measurement for the second receive beam by the first threshold amount with a confidence level exceeding a second threshold amount.

In some examples, the triggering condition is satisfied when a predicted measurement for a first receive beam of the set of receive beams exceeds, by a threshold, each of one or more second predicted measurements for corresponding one or more second receive beams of the set of receive beams, where the one or more second receive beams have corresponding actual measurements in the first measurement report, and where the first receive beam is different from any of the one or more second receive beams.

In some cases, the UE 115-c may receive, from the network entity 105-c, control signaling indicating the triggering condition in association with a serving cell or an active BWP for the UE 115-c.

In some examples, the UE 115-c may transmit the second measurement report at 525 via multiplexing an aperiodic CSI report on an uplink shared channel transmission, the aperiodic CSI report including the second measurement report, and a MAC header of the uplink shared channel transmission indicates that the aperiodic CSI report is multiplexed on the uplink shared channel transmission.

In some examples, the UE 115-c may transmit, to the network entity 105-c during an initial access procedure, an indication of the triggering condition. In some examples, the UE 115-c may communicate, with the network entity 105-c, control signaling updating the triggering condition.

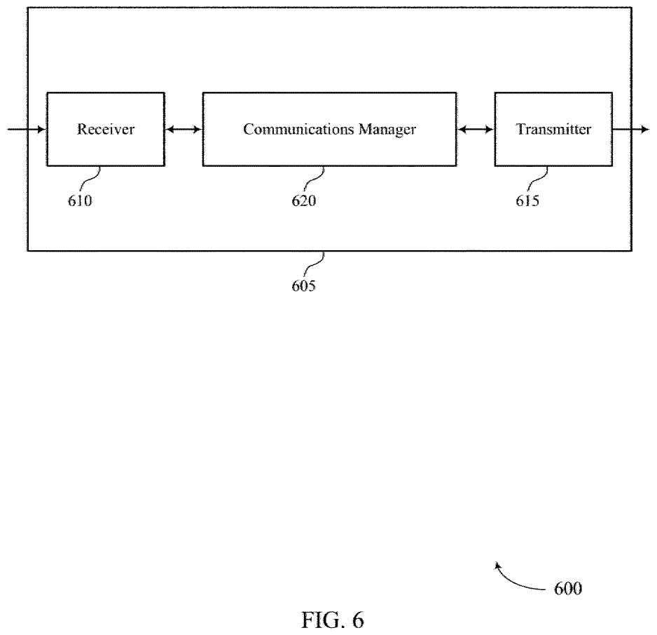

FIG. 6 illustrates a block diagram 600 of a device 605 that supports opportunistic time domain beam prediction reporting in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to opportunistic time domain beam prediction reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to opportunistic time domain beam prediction reporting). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of opportunistic time domain beam prediction reporting as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving, from a network entity, a set of reference signals. The communications manager 620 may be configured as or otherwise support a means for transmitting, to the network entity, a first measurement report that indicates a set of actual channel measurements generated based on measurements of the set of reference signals on a corresponding set of receive beams at the UE. The communications manager 620 may be configured as or otherwise support a means for transmitting, to the network entity, a second measurement report that indicates a set of predicted channel measurements, transmission of the second measurement report based on the set of predicted channel measurements satisfying a triggering condition, the set of predicted channel measurements associated with the set of receive beams at the UE.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources.

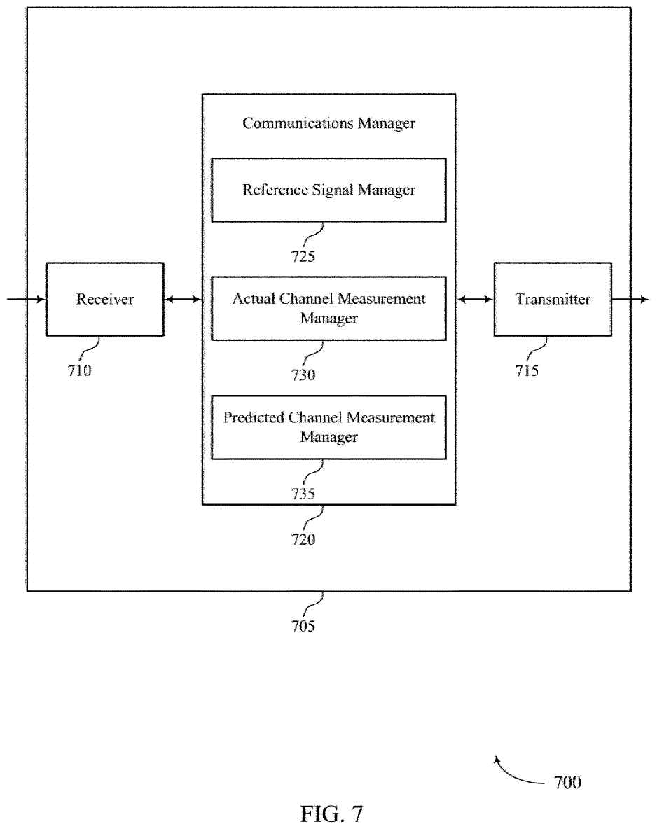

FIG. 7 illustrates a block diagram 700 of a device 705 that supports opportunistic time domain beam prediction reporting in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to opportunistic time domain beam prediction reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to opportunistic time domain beam prediction reporting). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of opportunistic time domain beam prediction reporting as described herein. For example, the communications manager 720 may include a reference signal manager 725, an actual channel measurement manager 730, a predicted channel measurement manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The reference signal manager 725 may be configured as or otherwise support a means for receiving, from a network entity, a set of reference signals. The actual channel measurement manager 730 may be configured as or otherwise support a means for transmitting, to the network entity, a first measurement report that indicates a set of actual channel measurements generated based on measurements of the set of reference signals on a corresponding set of receive beams at the UE. The predicted channel measurement manager 735 may be configured as or otherwise support a means for transmitting, to the network entity, a second measurement report that indicates a set of predicted channel measurements, transmission of the second measurement report based on the set of predicted channel measurements satisfying a triggering condition, the set of predicted channel measurements associated with the set of receive beams at the UE.

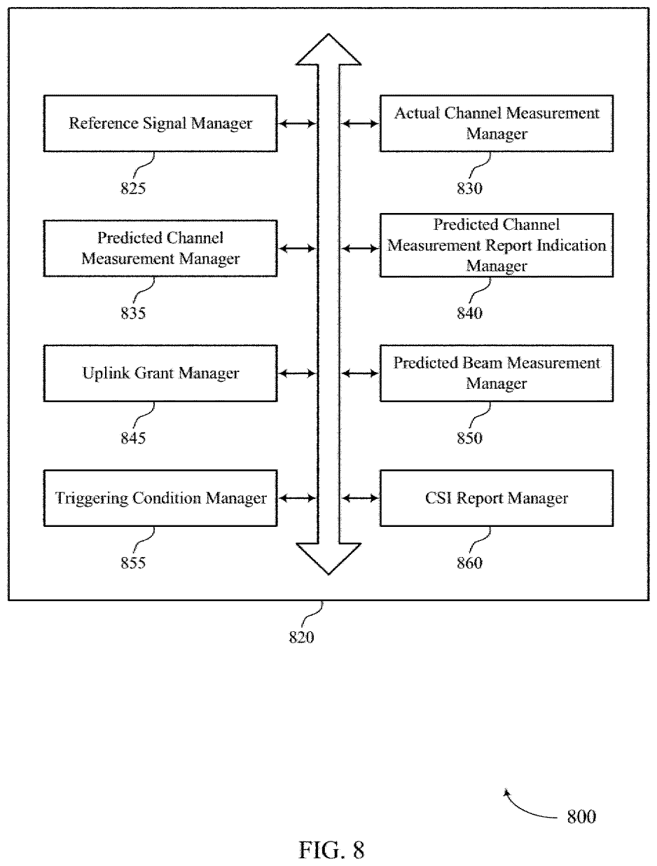

FIG. 8 illustrates a block diagram 800 of a communications manager 820 that supports opportunistic time domain beam prediction reporting in accordance with one or more aspects of the present disclosure. The communications manager 820 may be an example of aspects of a communications manager 620, a communications manager 720, or both, as described herein. The communications manager 820, or various components thereof, may be an example of means for performing various aspects of opportunistic time domain beam prediction reporting as described herein. For example, the communications manager 820 may include a reference signal manager 825, an actual channel measurement manager 830, a predicted channel measurement manager 835, a predicted channel measurement report indication manager 840, an uplink grant manager 845, a predicted beam measurement manager 850, a triggering condition manager 855, a CSI report manager 860, or any combination thereof. Each of these components may communicate, directly or indirectly, with one another (e.g., via one or more buses).

The communications manager 820 may support wireless communications at a UE in accordance with examples as disclosed herein. The reference signal manager 825 may be configured as or otherwise support a means for receiving, from a network entity, a set of reference signals. The actual channel measurement manager 830 may be configured as or otherwise support a means for transmitting, to the network entity, a first measurement report that indicates a set of actual channel measurements generated based on measurements of the set of reference signals on a corresponding set of receive beams at the UE. The predicted channel measurement manager 835 may be configured as or otherwise support a means for transmitting, to the network entity, a second measurement report that indicates a set of predicted channel measurements, transmission of the second measurement report based on the set of predicted channel measurements satisfying a triggering condition, the set of predicted channel measurements associated with the set of receive beams at the UE.

In some examples, the predicted channel measurement report indication manager 840 may be configured as or otherwise support a means for transmitting, to the network entity based on the set of predicted channel measurements satisfying the triggering condition, an indication that the UE will transmit the second measurement report. In some examples, the uplink grant manager 845 may be configured as or otherwise support a means for receiving, from the network entity and in response to the indication that the UE will transmit the second measurement report, a grant for an uplink resource for the second measurement report, where the second measurement report is transmitted via the uplink resource.

In some examples, to support transmitting the indication that the UE will transmit the second measurement report, the predicted channel measurement report indication manager 840 may be configured as or otherwise support a means for transmitting the indication in the first measurement report.

In some examples, the triggering condition manager 855 may be configured as or otherwise support a means for receiving, from the network entity, control signaling indicating the triggering condition in association with a CSI reporting configuration, where the first measurement report is a CSI report.

In some examples, to support transmitting the indication in the first measurement report, the CSI report manager 860 may be configured as or otherwise support a means for transmitting the indication in a first CSI report, where the grant for the uplink resource schedules transmission of a second CSI report, where the first measurement report is the first CSI report and the second measurement report is the second CSI report.

In some examples, a first CSI report setting of the first CSI report includes a second identifier for a second CSI report setting of the second CSI report, or the second CSI report setting of the second CSI report includes a first identifier for the first CSI report setting of the first CSI report.

In some examples, a MAC-CE that activates the grant for the uplink resource includes an indication of a first identifier for a first CSI report setting of the first CSI report.

In some examples, to support set of predicted channel measurements satisfying the triggering condition, the predicted beam measurement manager 850 may be configured as or otherwise support a means for a first predicted measurement for a first receive beam exceeding a second predicted measurement for a second receive beam by a first threshold amount, both the first receive beam and the second receive beam being of the set of receive beams, the second receive beam corresponding to a strongest measurement included in the first measurement report, or the second receive beam being associated with a TCI state associated with a most recently scheduled downlink transmission.

In some examples, to support set of predicted channel measurements satisfying the triggering condition, the predicted beam measurement manager 850 may be configured as or otherwise support a means for determining that the first predicted measurement for the first receive beam exceeds the second predicted measurement for the second receive beam by the first threshold amount with a confidence level exceeding a second threshold amount.

In some examples, to support set of predicted channel measurements satisfying the triggering condition, the predicted beam measurement manager 850 may be configured as or otherwise support a means for a predicted measurement for a first receive beam of the set of receive beams exceeding, by a threshold, each of one or more second predicted measurements for corresponding one or more second receive beams of the set of receive beams, where the one or more second receive beams have corresponding actual measurements in the first measurement report, and where the first receive beam is different from any of the one or more second receive beams.

In some examples, the triggering condition manager 855 may be configured as or otherwise support a means for receiving, from the network entity, control signaling indicating the triggering condition in association with a serving cell or an active bandwidth part for the UE.

In some examples, to support transmitting the second measurement report, the CSI report manager 860 may be configured as or otherwise support a means for multiplexing an aperiodic CSI report on an uplink shared channel transmission, the aperiodic CSI report including the second measurement report, where a MAC header of the uplink shared channel transmission indicates that the aperiodic CSI report is multiplexed on the uplink shared channel transmission.

In some examples, the triggering condition manager 855 may be configured as or otherwise support a means for transmitting, to the network entity during an initial access procedure with the network entity, an indication of the triggering condition.

In some examples, the triggering condition manager 855 may be configured as or otherwise support a means for communicating, with the network entity, control signaling updating the triggering condition.

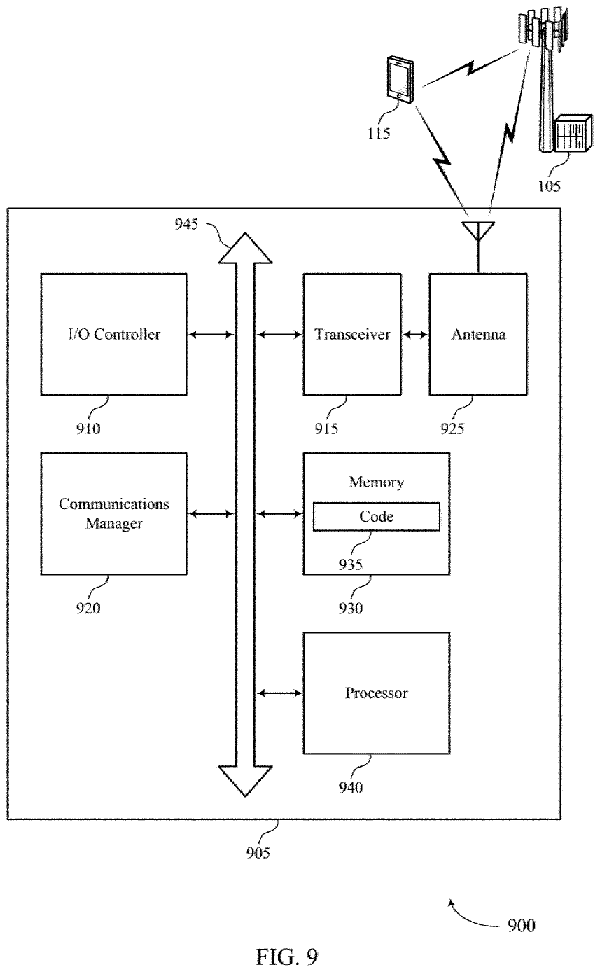

FIG. 9 illustrates a diagram of a system 900 including a device 905 that supports opportunistic time domain beam prediction reporting in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting opportunistic time domain beam prediction reporting). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, from a network entity, a set of reference signals. The communications manager 920 may be configured as or otherwise support a means for transmitting, to the network entity, a first measurement report that indicates a set of actual channel measurements generated based on measurements of the set of reference signals on a corresponding set of receive beams at the UE. The communications manager 920 may be configured as or otherwise support a means for transmitting, to the network entity, a second measurement report that indicates a set of predicted channel measurements, transmission of the second measurement report based on the set of predicted channel measurements satisfying a triggering condition, the set of predicted channel measurements associated with the set of receive beams at the UE.

By including or configuring the communications manager 920 in accordance with examples as described herein, the device 905 may support techniques for reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of opportunistic time domain beam prediction reporting as described herein, or the processor 940 and the memory 930 may be otherwise configured to perform or support such operations.

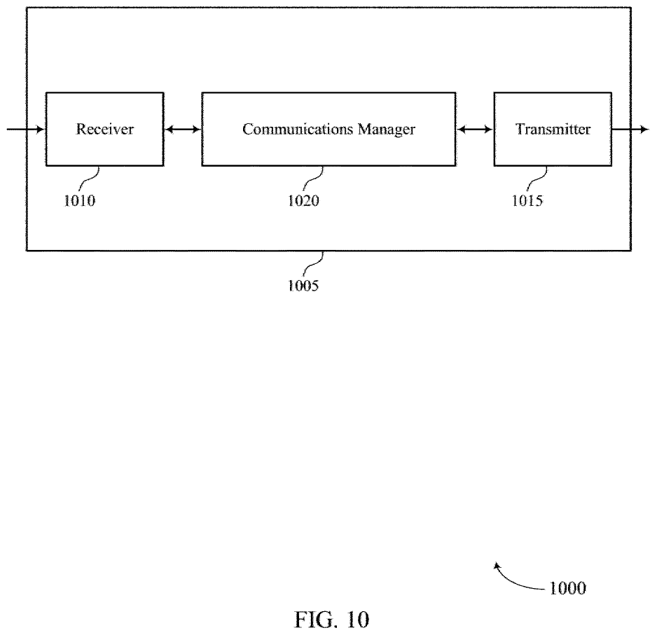

FIG. 10 illustrates a block diagram 1000 of a device 1005 that supports opportunistic time domain beam prediction reporting in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of opportunistic time domain beam prediction reporting as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for transmitting, to a UE, a set of reference signals. The communications manager 1020 may be configured as or otherwise support a means for receiving, from the UE, a first measurement report that indicates a set of actual channel measurements generated based on measurements of the set of reference signals on a corresponding set of receive beams at the UE. The communications manager 1020 may be configured as or otherwise support a means for receiving, from the UE, a second measurement report that indicates a set of predicted channel measurements, transmission of the second measurement report based on the set of predicted channel measurements satisfying a triggering condition, the set of predicted channel measurements associated with the set of receive beams at the UE.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources.

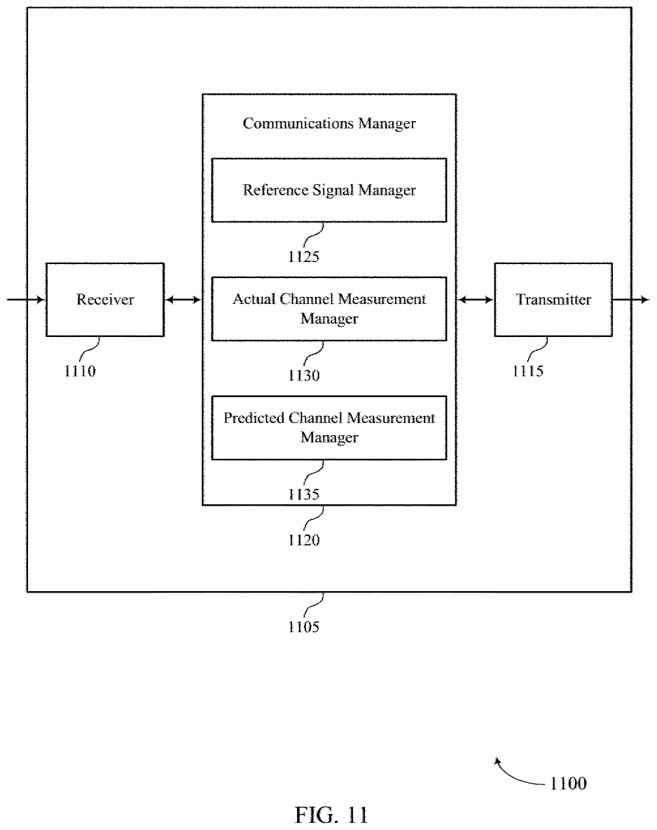

FIG. 11 illustrates a block diagram 1100 of a device 1105 that supports opportunistic time domain beam prediction reporting in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of opportunistic time domain beam prediction reporting as described herein. For example, the communications manager 1120 may include a reference signal manager 1125, an actual channel measurement manager 1130, a predicted channel measurement manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The reference signal manager 1125 may be configured as or otherwise support a means for transmitting, to a UE, a set of reference signals. The actual channel measurement manager 1130 may be configured as or otherwise support a means for receiving, from the UE, a first measurement report that indicates a set of actual channel measurements generated based on measurements of the set of reference signals on a corresponding set of receive beams at the UE. The predicted channel measurement manager 1135 may be configured as or otherwise support a means for receiving, from the UE, a second measurement report that indicates a set of predicted channel measurements, transmission of the second measurement report based on the set of predicted channel measurements satisfying a triggering condition, the set of predicted channel measurements associated with the set of receive beams at the UE.

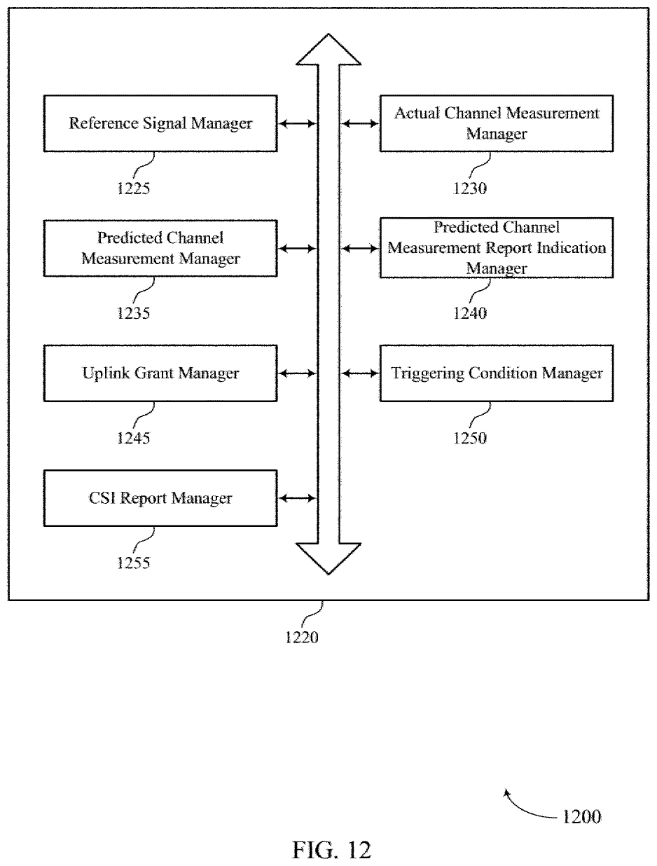

FIG. 12 illustrates a block diagram 1200 of a communications manager 1220 that supports opportunistic time domain beam prediction reporting in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of opportunistic time domain beam prediction reporting as described herein. For example, the communications manager 1220 may include a reference signal manager 1225, an actual channel measurement manager 1230, a predicted channel measurement manager 1235, a predicted channel measurement report indication manager 1240, an uplink grant manager 1245, a triggering condition manager 1250, a CSI report manager 1255, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The reference signal manager 1225 may be configured as or otherwise support a means for transmitting, to a UE, a set of reference signals. The actual channel measurement manager 1230 may be configured as or otherwise support a means for receiving, from the UE, a first measurement report that indicates a set of actual channel measurements generated based on measurements of the set of reference signals on a corresponding set of receive beams at the UE. The predicted channel measurement manager 1235 may be configured as or otherwise support a means for receiving, from the UE, a second measurement report that indicates a set of predicted channel measurements, transmission of the second measurement report based on the set of predicted channel measurements satisfying a triggering condition, the set of predicted channel measurements associated with the set of receive beams at the UE.

In some examples, the predicted channel measurement report indication manager 1240 may be configured as or otherwise support a means for receiving, from the UE based on the set of predicted channel measurements satisfying the triggering condition, an indication that the UE will transmit the second measurement report. In some examples, the uplink grant manager 1245 may be configured as or otherwise support a means for transmitting, to the UE and in response to the indication that the UE will transmit the second measurement report, a grant for an uplink resource for the second measurement report, where the second measurement report is transmitted via the uplink resource.

In some examples, to support receiving the indication that the UE will transmit the second measurement report, the predicted channel measurement report indication manager 1240 may be configured as or otherwise support a means for receiving the indication in the first measurement report.

In some examples, the triggering condition manager 1250 may be configured as or otherwise support a means for transmitting, to the UE, control signaling indicating the triggering condition in association with a CSI reporting configuration, where the first measurement report is a CSI report.

In some examples, to support receiving the indication in the first measurement report, the CSI report manager 1255 may be configured as or otherwise support a means for receiving the indication in a first CSI report, where the grant for the uplink resource schedules transmission of a second CSI report, where the first measurement report is the first CSI report and the second measurement report is the second CSI report.

In some examples, a first CSI report setting of the first CSI report includes a second identifier for a second CSI report setting of the second CSI report, or the second CSI report setting of the second CSI report includes a first identifier for the first CSI report setting of the first CSI report.

In some examples, a MAC-CE that activates the grant for the uplink resource includes an indication of a first identifier for a first CSI report setting of the first CSI report.

In some examples, to support set of predicted channel measurements satisfying the triggering condition, the triggering condition manager 1250 may be configured as or otherwise support a means for a first predicted measurement for a first receive beam exceeding a second predicted measurement for a second receive beam by a first threshold amount, both the first receive beam and the second receive beam being of the set of receive beams, the second receive beam corresponding to a strongest measurement included in the first measurement report, or the second receive beam being associated with a TCI state associated with a most recently scheduled downlink transmission.

In some examples, to support set of predicted channel measurements satisfying the triggering condition, the triggering condition manager 1250 may be configured as or otherwise support a means for a predicted measurement for a first receive beam of the set of receive beams exceeding, by a threshold, each of one or more second predicted measurements for corresponding one or more second receive beams of the set of receive beams, where the one or more second receive beams have corresponding actual measurements in the first measurement report, and where the first receive beam is different from any of the one or more second receive beams.

In some examples, the triggering condition manager 1250 may be configured as or otherwise support a means for transmitting, to the UE, control signaling indicating the triggering condition in association with a serving cell or an active bandwidth part for the UE.

In some examples, to support receiving the second measurement report, the CSI report manager 1255 may be configured as or otherwise support a means for receiving an aperiodic CSI report multiplexed on an uplink shared channel transmission, the aperiodic CSI report including the second measurement report, where a MAC header of the uplink shared channel transmission indicates that the aperiodic CSI report is multiplexed on the uplink shared channel transmission.

In some examples, the triggering condition manager 1250 may be configured as or otherwise support a means for receiving, from the UE, during an initial access procedure with the UE, an indication of the triggering condition.

In some examples, the triggering condition manager 1250 may be configured as or otherwise support a means for communicating, with the UE, control signaling updating the triggering condition.

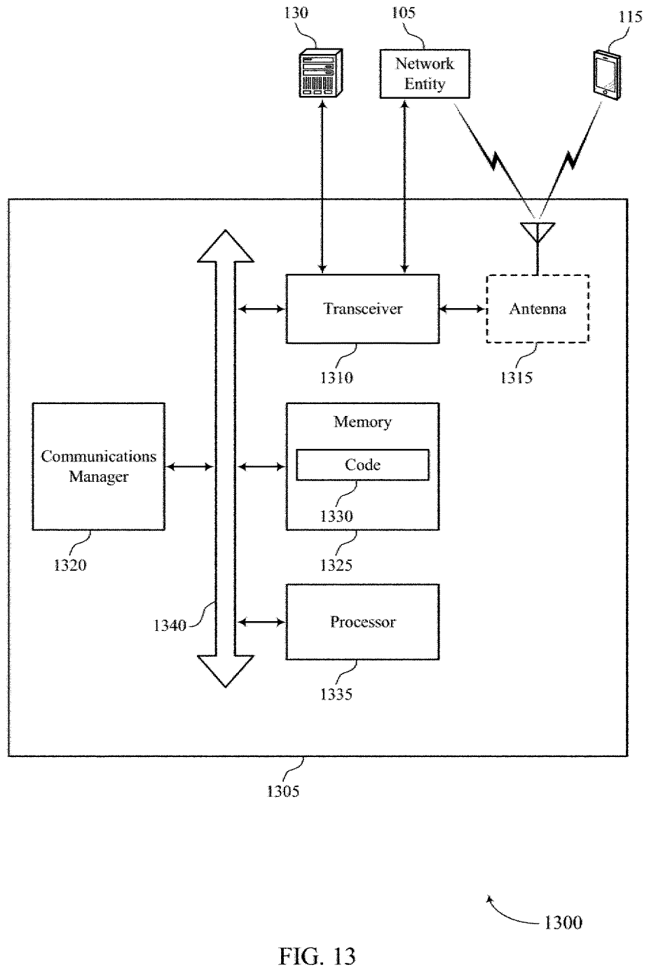

FIG. 13 illustrates a diagram of a system 1300 including a device 1305 that supports opportunistic time domain beam prediction reporting in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting opportunistic time domain beam prediction reporting). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for transmitting, to a UE, a set of reference signals. The communications manager 1320 may be configured as or otherwise support a means for receiving, from the UE, a first measurement report that indicates a set of actual channel measurements generated based on measurements of the set of reference signals on a corresponding set of receive beams at the UE. The communications manager 1320 may be configured as or otherwise support a means for receiving, from the UE, a second measurement report that indicates a set of predicted channel measurements, transmission of the second measurement report based on the set of predicted channel measurements satisfying a triggering condition, the set of predicted channel measurements associated with the set of receive beams at the UE.

By including or configuring the communications manager 1320 in accordance with examples as described herein, the device 1305 may support techniques for reduced power consumption, more efficient utilization of communication resources, improved coordination between devices, longer battery life, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of opportunistic time domain beam prediction reporting as described herein, or the processor 1335 and the memory 1325 may be otherwise configured to perform or support such operations.

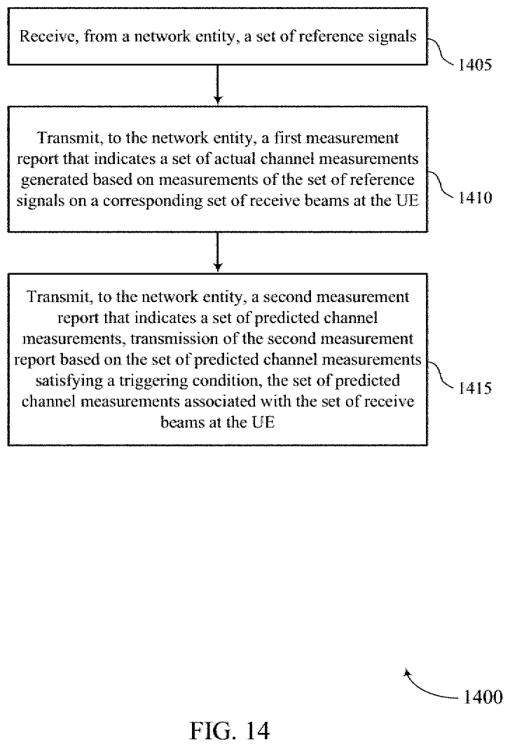

FIG. 14 illustrates a flowchart showing a method 1400 that supports opportunistic time domain beam prediction reporting in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a set of reference signals. The operations of 1405 may be performed in accordance with examples as disclosed herein. In some examples, aspects of the operations of 1405 may be performed by a reference signal manager 825 as described with reference to FIG. 8.

At 1410, the method may include transmitting, to the network entity, a first measurement report that indicates a set of actual channel measurements generated based on measurements of the set of reference signals on a corresponding set of receive beams at the UE. The operations of 1410 may be performed in accordance with examples as disclosed herein. In some examples, aspects of the operations of 1410 may be performed by an actual channel measurement manager 830 as described with reference to FIG. 8.

At 1415, the method may include transmitting, to the network entity, a second measurement report that indicates a set of predicted channel measurements, transmission of the second measurement report based on the set of predicted channel measurements satisfying a triggering condition, the set of predicted channel measurements associated with the set of receive beams at the UE. The operations of 1415 may be performed in accordance with examples as disclosed herein. In some examples, aspects of the operations of 1415 may be performed by a predicted channel measurement manager 835 as described with reference to FIG. 8.

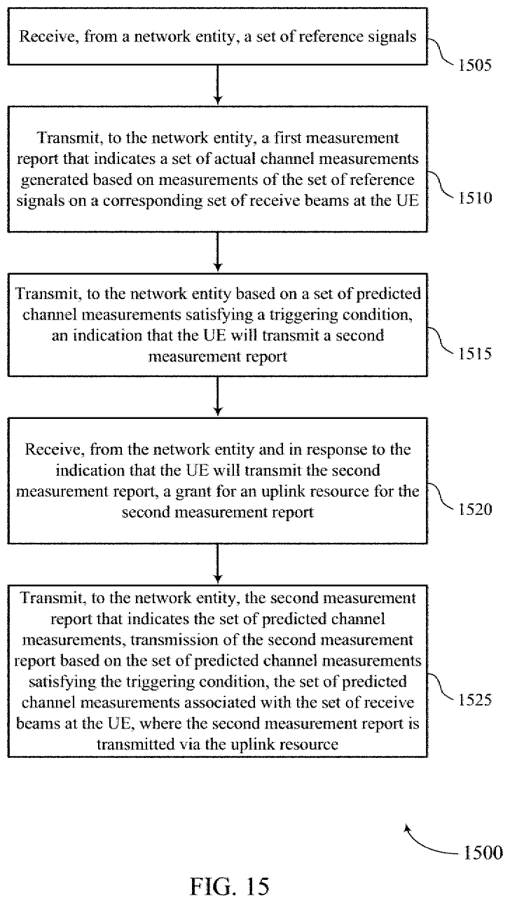

FIG. 15 illustrates a flowchart showing a method 1500 that supports opportunistic time domain beam prediction reporting in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a set of reference signals. The operations of 1505 may be performed in accordance with examples as disclosed herein. In some examples, aspects of the operations of 1505 may be performed by a reference signal manager 825 as described with reference to FIG. 8.

At 1510, the method may include transmitting, to the network entity, a first measurement report that indicates a set of actual channel measurements generated based on measurements of the set of reference signals on a corresponding set of receive beams at the UE. The operations of 1510 may be performed in accordance with examples as disclosed herein. In some examples, aspects of the operations of 1510 may be performed by an actual channel measurement manager 830 as described with reference to FIG. 8.

At 1515, the method may include transmitting, to the network entity based on a set of predicted channel measurements satisfying a triggering condition, an indication that the UE will transmit a second measurement report. The operations of 1515 may be performed in accordance with examples as disclosed herein. In some examples, aspects of the operations of 1515 may be performed by a predicted channel measurement report indication manager 840 as described with reference to FIG. 8.

At 1520, the method may include receiving, from the network entity and in response to the indication that the UE will transmit the second measurement report, a grant for an uplink resource for the second measurement report. The operations of 1520 may be performed in accordance with examples as disclosed herein. In some examples, aspects of the operations of 1520 may be performed by an uplink grant manager 845 as described with reference to FIG. 8.

At 1525, the method may include transmitting, to the network entity, the second measurement report that indicates the set of predicted channel measurements, transmission of the second measurement report based on the set of predicted channel measurements satisfying the triggering condition, the set of predicted channel measurements associated with the set of receive beams at the UE, where the second measurement report is transmitted via the uplink resource. The operations of 1525 may be performed in accordance with examples as disclosed herein. In some examples, aspects of the operations of 1525 may be performed by a predicted channel measurement manager 835 as described with reference to FIG. 8.

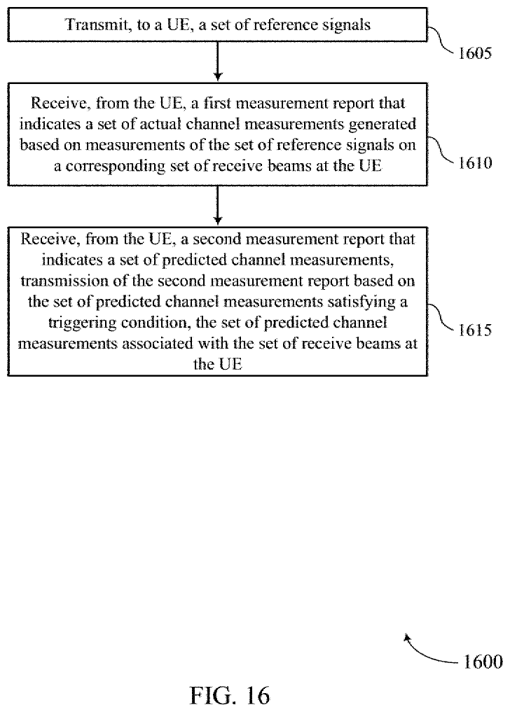

FIG. 16 illustrates a flowchart showing a method 1600 that supports opportunistic time domain beam prediction reporting in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, a set of reference signals. The operations of 1605 may be performed in accordance with examples as disclosed herein. In some examples, aspects of the operations of 1605 may be performed by a reference signal manager 1225 as described with reference to FIG. 12.

At 1610, the method may include receiving, from the UE, a first measurement report that indicates a set of actual channel measurements generated based on measurements of the set of reference signals on a corresponding set of receive beams at the UE. The operations of 1610 may be performed in accordance with examples as disclosed herein. In some examples, aspects of the operations of 1610 may be performed by an actual channel measurement manager 1230 as described with reference to FIG. 12.

At 1615, the method may include receiving, from the UE, a second measurement report that indicates a set of predicted channel measurements, transmission of the second measurement report based on the set of predicted channel measurements satisfying a triggering condition, the set of predicted channel measurements associated with the set of receive beams at the UE. The operations of 1615 may be performed in accordance with examples as disclosed herein. In some examples, aspects of the operations of 1615 may be performed by a predicted channel measurement manager 1235 as described with reference to FIG. 12.

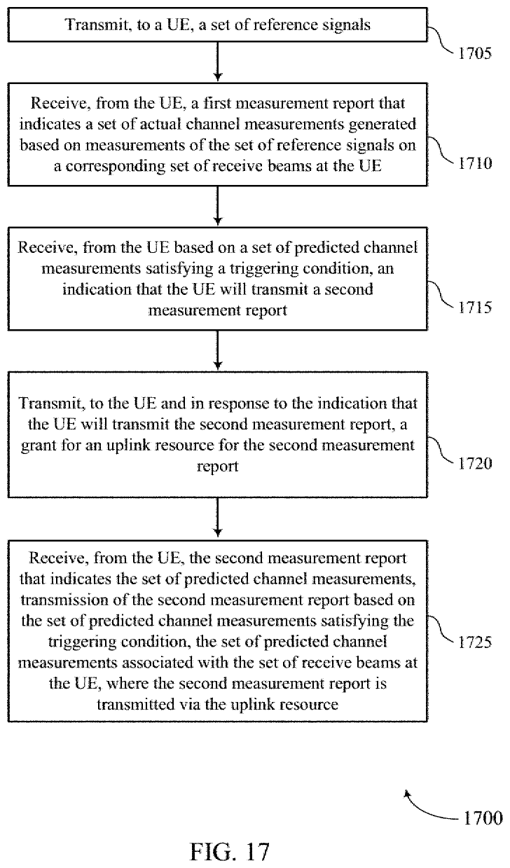

FIG. 17 illustrates a flowchart showing a method 1700 that supports opportunistic time domain beam prediction reporting in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, a set of reference signals. The operations of 1705 may be performed in accordance with examples as disclosed herein. In some examples, aspects of the operations of 1705 may be performed by a reference signal manager 1225 as described with reference to FIG. 12.

At 1710, the method may include receiving, from the UE, a first measurement report that indicates a set of actual channel measurements generated based on measurements of the set of reference signals on a corresponding set of receive beams at the UE. The operations of 1710 may be performed in accordance with examples as disclosed herein. In some examples, aspects of the operations of 1710 may be performed by an actual channel measurement manager 1230 as described with reference to FIG. 12.

At 1715, the method may include receiving, from the UE based on a set of predicted channel measurements satisfying a triggering condition, an indication that the UE will transmit a second measurement report. The operations of 1715 may be performed in accordance with examples as disclosed herein. In some examples, aspects of the operations of 1715 may be performed by a predicted channel measurement report indication manager 1240 as described with reference to FIG. 12.

At 1720, the method may include transmitting, to the UE and in response to the indication that the UE will transmit the second measurement report, a grant for an uplink resource for the second measurement report. The operations of 1720 may be performed in accordance with examples as disclosed herein. In some examples, aspects of the operations of 1720 may be performed by an uplink grant manager 1245 as described with reference to FIG. 12.

At 1725, the method may include receiving, from the UE, the second measurement report that indicates the set of predicted channel measurements, transmission of the second measurement report based on the set of predicted channel measurements satisfying the triggering condition, the set of predicted channel measurements associated with the set of receive beams at the UE, where the second measurement report is transmitted via the uplink resource. The operations of 1725 may be performed in accordance with examples as disclosed herein. In some examples, aspects of the operations of 1725 may be performed by a predicted channel measurement manager 1235 as described with reference to FIG. 12.

The following provides an overview of aspects of the present disclosure:
Aspect 1: A method for wireless communications at a UE, comprising: receiving, from a network entity, a set of reference signals; transmitting, to the network entity, a first measurement report that indicates a set of actual channel measurements generated based at least in part on measurements of the set of reference signals on a corresponding set of receive beams at the UE; and transmitting, to the network entity, a second measurement report that indicates a set of predicted channel measurements, transmission of the second measurement report based at least in part on the set of predicted channel measurements satisfying a triggering condition, the set of predicted channel measurements associated with the set of receive beams at the UE.
Aspect 2: The method of aspect 1, further comprising: transmitting, to the network entity based at least in part on the set of predicted channel measurements satisfying the triggering condition, an indication that the UE will transmit the second measurement report; and receiving, from the network entity and in response to the indication that the UE will transmit the second measurement report, a grant for an uplink resource for the second measurement report, wherein the second measurement report is transmitted via the uplink resource.
Aspect 3: The method of aspect 2, wherein transmitting the indication that the UE will transmit the second measurement report comprises: transmitting the indication in the first measurement report.
Aspect 4: The method of aspect 3, further comprising: receiving, from the network entity, control signaling indicating the triggering condition in association with a CSI reporting configuration, wherein the first measurement report is a CSI report.
Aspect 5: The method of any of aspects 3 through 4, wherein transmitting the indication in the first measurement report comprises: transmitting the indication in a first CSI report, wherein the grant for the uplink resource schedules transmission of a second CSI report, wherein the first measurement report is the first CSI report and the second measurement report is the second CSI report.
Aspect 6: The method of aspect 5, wherein a first CSI report setting of the first CSI report includes a second identifier for a second CSI report setting of the second CSI report, or the second CSI report setting of the second CSI report includes a first identifier for the first CSI report setting of the first CSI report.
Aspect 7: The method of any of aspects 5 through 6, wherein a MAC-CE that activates the grant for the uplink resource comprises an indication of a first identifier for a first CSI report setting of the first CSI report.
Aspect 8: The method of any of aspects 1 through 7, wherein the set of predicted channel measurements satisfying the triggering condition comprises: a first predicted measurement for a first receive beam exceeding a second predicted measurement for a second receive beam by a first threshold amount, both the first receive beam and the second receive beam being of the set of receive beams, the second receive beam corresponding to a strongest measurement included in the first measurement report, or the second receive beam being associated with a TCI state associated with a most recently scheduled downlink transmission.
Aspect 9: The method of aspect 8, wherein the set of predicted channel measurements satisfying the triggering condition comprises: determining that the first predicted measurement for the first receive beam exceeds the second predicted measurement for the second receive beam by the first threshold amount with a confidence level exceeding a second threshold amount.
Aspect 10: The method of any of aspects 1 through 9, wherein the set of predicted channel measurements satisfying the triggering condition comprises: a predicted measurement for a first receive beam of the set of receive beams exceeding, by a threshold, each of one or more second predicted measurements for corresponding one or more second receive beams of the set of receive beams, wherein the one or more second receive beams have corresponding actual measurements in the first measurement report, and wherein the first receive beam is different from any of the one or more second receive beams.
Aspect 11: The method of any of aspects 1 through 10, further comprising: receiving, from the network entity, control signaling indicating the triggering condition in association with a serving cell or an active bandwidth part for the UE.
Aspect 12: The method of any of aspects 1 through 11, wherein transmitting the second measurement report comprises: multiplexing an aperiodic CSI report on an uplink shared channel transmission, the aperiodic CSI report comprising the second measurement report, wherein a medium access control header of the uplink shared channel transmission indicates that the aperiodic CSI report is multiplexed on the uplink shared channel transmission.
Aspect 13: The method of any of aspects 1 through 12, further comprising: transmitting, to the network entity during an initial access procedure with the network entity, an indication of the triggering condition.
Aspect 14: The method of aspect 13, further comprising: communicating, with the network entity, control signaling updating the triggering condition.
Aspect 15: A method for wireless communications at a network entity, comprising: transmitting, to a UE, a set of reference signals; receiving, from the UE, a first measurement report that indicates a set of actual channel measurements generated based at least in part on measurements of the set of reference signals on a corresponding set of receive beams at the UE; and receiving, from the UE, a second measurement report that indicates a set of predicted channel measurements, transmission of the second measurement report based at least in part on the set of predicted channel measurements satisfying a triggering condition, the set of predicted channel measurements associated with the set of receive beams at the UE.
Aspect 16: The method of aspect 15, further comprising: receiving, from the UE based at least in part on the set of predicted channel measurements satisfying the triggering condition, an indication that the UE will transmit the second measurement report; and transmitting, to the UE and in response to the indication that the UE will transmit the second measurement report, a grant for an uplink resource for the second measurement report, wherein the second measurement report is transmitted via the uplink resource.
Aspect 17: The method of aspect 16, wherein receiving the indication that the UE will transmit the second measurement report comprises: receiving the indication in the first measurement report.
Aspect 18: The method of aspect 17, further comprising: transmitting, to the UE, control signaling indicating the triggering condition in association with a CSI reporting configuration, wherein the first measurement report is a CSI report.
Aspect 19: The method of any of aspects 17 through 18, wherein receiving the indication in the first measurement report comprises: receiving the indication in a first CSI report, wherein the grant for the uplink resource schedules transmission of a second CSI report, wherein the first measurement report is the first CSI report and the second measurement report is the second CSI report.
Aspect 20: The method of aspect 19, wherein a first CSI report setting of the first CSI report includes a second identifier for a second CSI report setting of the second CSI report, or the second CSI report setting of the second CSI report includes a first identifier for the first CSI report setting of the first CSI report.
Aspect 21: The method of any of aspects 19 through 20, wherein a MAC-CE that activates the grant for the uplink resource comprises an indication of a first identifier for a first CSI report setting of the first CSI report.
Aspect 22: The method of any of aspects 15 through 21, wherein the set of predicted channel measurements satisfying the triggering condition comprises: a first predicted measurement for a first receive beam exceeding a second predicted measurement for a second receive beam by a first threshold amount, both the first receive beam and the second receive beam being of the set of receive beams, the second receive beam corresponding to a strongest measurement included in the first measurement report, or the second receive beam being associated with a TCI state associated with a most recently scheduled downlink transmission.
Aspect 23: The method of any of aspects 15 through 22, wherein the set of predicted channel measurements satisfying the triggering condition comprises: a predicted measurement for a first receive beam of the set of receive beams exceeding, by a threshold, each of one or more second predicted measurements for corresponding one or more second receive beams of the set of receive beams, wherein the one or more second receive beams have corresponding actual measurements in the first measurement report, and wherein the first receive beam is different from any of the one or more second receive beams.
Aspect 24: The method of any of aspects 15 through 23, further comprising: transmitting, to the UE, control signaling indicating the triggering condition in association with a serving cell or an active bandwidth part for the UE.
Aspect 25: The method of any of aspects 15 through 24, wherein receiving the second measurement report comprises: receiving an aperiodic CSI report multiplexed on an uplink shared channel transmission, the aperiodic CSI report comprising the second measurement report, wherein a medium access control header of the uplink shared channel transmission indicates that the aperiodic CSI report is multiplexed on the uplink shared channel transmission.
Aspect 26: The method of any of aspects 15 through 25, further comprising: receiving, from the UE, during an initial access procedure with the UE, an indication of the triggering condition.
Aspect 27: The method of aspect 26, further comprising: communicating, with the UE, control signaling updating the triggering condition.
Aspect 28: An apparatus for wireless communications at a UE, comprising a processor; memory coupled with the processor; and instructions stored in the memory and executable by the processor to cause the apparatus to perform a method of any of aspects 1 through 14.
Aspect 29: An apparatus for wireless communications at a UE, comprising at least one means for performing a method of any of aspects 1 through 14.
Aspect 30: A non-transitory computer-readable medium storing code for wireless communications at a UE, the code comprising instructions executable by a processor to perform a method of any of aspects 1 through 14.
Aspect 31: An apparatus for wireless communications at a network entity, comprising a processor; memory coupled with the processor; and instructions stored in the memory and executable by the processor to cause the apparatus to perform a method of any of aspects 15 through 27.
Aspect 32: An apparatus for wireless communications at a network entity, comprising at least one means for performing a method of any of aspects 15 through 27.
Aspect 33: A non-transitory computer-readable medium storing code for wireless communications at a network entity, the code comprising instructions executable by a processor to perform a method of any of aspects 15 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

Please enter the following amendments to the claims:

1. A method for wireless communications at a user equipment (UE), comprising:
receiving, from a network entity, a set of reference signals;
transmitting, to the network entity, a first measurement report that indicates a set of actual channel measurements generated based at least in part on measurements of the set of reference signals on a corresponding set of receive beams at the UE; and
transmitting, to the network entity, a second measurement report that indicates a set of predicted channel measurements, transmission of the second measurement report based at least in part on the set of predicted channel measurements satisfying a triggering condition, the set of predicted channel measurements associated with the set of receive beams at the UE.

2. The method of claim 1, further comprising:
transmitting, to the network entity based at least in part on the set of predicted channel measurements satisfying the triggering condition, an indication that the UE will transmit the second measurement report; and
receiving, from the network entity and in response to the indication that the UE will transmit the second measurement report, a grant for an uplink resource for the second measurement report, wherein the second measurement report is transmitted via the uplink resource.

3. The method of claim 2, wherein transmitting the indication that the UE will transmit the second measurement report comprises:
transmitting the indication in the first measurement report.

4. The method of claim 3, further comprising:
receiving, from the network entity, control signaling indicating the triggering condition in association with a channel state information reporting configuration, wherein the first measurement report is a channel state information report.

5. The method of claim 3, wherein transmitting the indication in the first measurement report comprises:
transmitting the indication in a first channel state information report, wherein the grant for the uplink resource schedules transmission of a second channel state information report, wherein the first measurement report is the first channel state information report and the second measurement report is the second channel state information report.

6-7. (canceled)

8. The method of claim 1, wherein the set of predicted channel measurements satisfying the triggering condition comprises:
a first predicted measurement for a first receive beam exceeding a second predicted measurement for a second receive beam by a first threshold amount, both the first receive beam and the second receive beam being of the set of receive beams, the second receive beam corresponding to a strongest measurement included in the first measurement report, or the second receive beam being associated with a transmission configuration indicator state associated with a most recently scheduled downlink transmission.

9. (canceled)

10. The method of claim 1, wherein the set of predicted channel measurements satisfying the triggering condition comprises:
a predicted measurement for a first receive beam of the set of receive beams exceeding, by a threshold, each of one or more second predicted measurements for corresponding one or more second receive beams of the set of receive beams, wherein the one or more second receive beams have corresponding actual measurements in the first measurement report, and wherein the first receive beam is different from any of the one or more second receive beams.

11. The method of claim 1, further comprising:
receiving, from the network entity, control signaling indicating the triggering condition in association with a serving cell or an active bandwidth part for the UE.

12. The method of claim 1, wherein transmitting the second measurement report comprises:
multiplexing an aperiodic channel state information report on an uplink shared channel transmission, the aperiodic channel state information report comprising the second measurement report, wherein a medium access control header of the uplink shared channel transmission indicates that the aperiodic channel state information report is multiplexed on the uplink shared channel transmission.

13. The method of claim 1, further comprising:
transmitting, to the network entity during an initial access procedure with the network entity, an indication of the triggering condition.

14. (canceled)

15. A method for wireless communications at a network entity, comprising:
transmitting, to a user equipment (UE), a set of reference signals;
receiving, from the UE, a first measurement report that indicates a set of actual channel measurements generated based at least in part on measurements of the set of reference signals on a corresponding set of receive beams at the UE; and
receiving, from the UE, a second measurement report that indicates a set of predicted channel measurements, transmission of the second measurement report based at least in part on the set of predicted channel measurements satisfying a triggering condition, the set of predicted channel measurements associated with the set of receive beams at the UE.

16. The method of claim 15, further comprising:
receiving, from the UE based at least in part on the set of predicted channel measurements satisfying the triggering condition, an indication that the UE will transmit the second measurement report; and
transmitting, to the UE and in response to the indication that the UE will transmit the second measurement report, a grant for an uplink resource for the second measurement report, wherein the second measurement report is transmitted via the uplink resource.

17. The method of claim 16, wherein receiving the indication that the UE will transmit the second measurement report comprises:
receiving the indication in the first measurement report.

18. The method of claim 17, further comprising:
transmitting, to the UE, control signaling indicating the triggering condition in association with a channel state information reporting configuration, wherein the first measurement report is a channel state information report.

19. The method of claim 17, wherein receiving the indication in the first measurement report comprises:
receiving the indication in a first channel state information report, wherein the grant for the uplink resource schedules transmission of a second channel state information report, wherein the first measurement report is the first channel state information report and the second measurement report is the second channel state information report.

20-21. (canceled)

22. The method of claim 15, wherein the set of predicted channel measurements satisfying the triggering condition comprises:
a first predicted measurement for a first receive beam exceeding a second predicted measurement for a second receive beam by a first threshold amount, both the first receive beam and the second receive beam being of the set of receive beams, the second receive beam corresponding to a strongest measurement included in the first measurement report, or the second receive beam being associated with a transmission configuration indicator state associated with a most recently scheduled downlink transmission.

23. (canceled)

24. The method of claim 15, further comprising:
transmitting, to the UE, control signaling indicating the triggering condition in association with a serving cell or an active bandwidth part for the UE.

25. The method of claim 15, wherein receiving the second measurement report comprises:
receiving an aperiodic channel state information report multiplexed on an uplink shared channel transmission, the aperiodic channel state information report comprising the second measurement report, wherein a medium access control header of the uplink shared channel transmission indicates that the aperiodic channel state information report is multiplexed on the uplink shared channel transmission.

26. The method of claim 15, further comprising:
receiving, from the UE, during an initial access procedure with the UE, an indication of the triggering condition.

27. (canceled)

28. An apparatus for wireless communications at a user equipment (UE), comprising:
a processor;
memory coupled with the processor; and
instructions stored in the memory and executable by the processor to cause the apparatus to:
receive, from a network entity, a set of reference signals;
transmit, to the network entity, a first measurement report that indicates a set of actual channel measurements generated based at least in part on measurements of the set of reference signals on a corresponding set of receive beams at the UE; and
transmit, to the network entity, a second measurement report that indicates a set of predicted channel measurements, transmission of the second measurement report based at least in part on the set of predicted channel measurements satisfying a triggering condition, the set of predicted channel measurements associated with the set of receive beams at the UE.

29-30. (canceled)
